(19) United States
(12) Patent Application Publication
(10) Pub. No.: US 2016/0077288 A1
(43) Pub. Date: Mar. 17, 2016

(54) SELF-WRITABLE WAVEGUIDE FOR FIBER CONNECTORS AND RELATED METHODS

(71) Applicants: Jan WATTÉ, Grimbergen (BE); Stefano BERI, Zaventem (BE); Paul VITS, Tielt-Winge (BE); Jeroen MISSINNE, Gent (BE); Sangram Keshari SAMAL, Jajpur, Orissa (IN); Mamoni DASH, Baripada, Orissa (IN); Geert Firmin VAN STEENBERGE, Sint-Amandsberg (BE); Peter Martha DUBRUEL, Oudenaarde (BE)

(72) Inventors: Jan WATTE, Grimbergen (BE); Stefano BERI, Zaventem (BE); Paul VITS, Tielt-Winge (BE); Jeroen MISSINEE, Gent (BE); Sangram Keshari SAMAL, Jajpur, Orissa (IN); Mamoni DASH, Baripada, Orissa (IN); Geert Firmin VAN STEENBERGE, Sint-Amandsberg (BE); Peter Martha DUBRUEL, Oudenaarde (BE)

(21) Appl. No.: 14/780,764

(22) PCT Filed: Apr. 2, 2014
(86) PCT No.: PCT/EP2014/056610

§ 371 Date: Sep. 28, 2015

Related U.S. Application Data
(60) Provisional application No. 61/807,596, filed on Apr. 2, 2013.
(60) Provisional application No. 61/946,388, filed on Feb. 28, 2014.

(51) Int. Cl. G02B 6/38; G02B 6/255

(52) U.S. Cl. CPC G02B 6/3846; G02B 6/2551; G02B 6/2555

(57) ABSTRACT

A splice with core-writing technology includes: (a) two fiber ends aligned and separated by a gap in a mechanical alignment system containing a polymerizable resin composition and photoinitiators; (b) the core bridge is written by launching UV or visible light through one or both fibers to be connected; and (c) the cladding is formed by flooding light or by thermal curing of polymerizable material to obtain the required refractive index contrast for waveguiding. The splice can be between two fibers, one of which is a connectorized stub. The fibers can be arranged in parallel or in optical alignment with a reflective device.

### BACKGROUND

Fibers can be connectorized in a variety of manners. One manner of connectorization is to strip an outer coating from an end of an optical fiber and then glue a ferrule to the fiber. A connector housing is positioned around the ferrule.

Other methods of connectorization can be accomplished by connecting a stub fiber of a connector to the cable with a mechanical splice or a fusion splice. A mechanical splice typically involves index-matching gel. A fusion splice typically involves the application of energy to fuse the two glass fibers together.

### SUMMARY

A self-writable waveguide can be utilized to connect two optical fibers, such as a connectorized fiber stub including at least a ferrule to an optical fiber cable, with a photocurable polymer or other material to form a core and a cladding in the gap area between the fiber stub and the optical fiber cable. The final result is a cold splice having light guiding capability.

Various devices and methods are disclosed for connecting two optical fibers together with self-writable waveguides.

### BRIEF DESCRIPTION OF THE DRAWINGS

FIG. 1 shows a chart of various options for methods of core formation and cladding formation according to certain aspects of the invention.

FIGS. 2A-C and 3A-C show a first fiber in position to be joined to a second fiber in an alignment device according to certain aspects of the invention.

FIGS. 4 and 5 show a connectorized fiber stub according to certain aspects of the invention.

FIGS. 6 and 7 show two alignment devices according to certain aspects of the invention.

FIGS. 8-10 show an apparatus for connectorizing a cable to a fiber stub held by a ferrule according to certain aspects of the invention.

FIG. 11 shows an alternative apparatus and method for curing the cladding material according to certain aspects of the invention.

### DETAILED DESCRIPTION

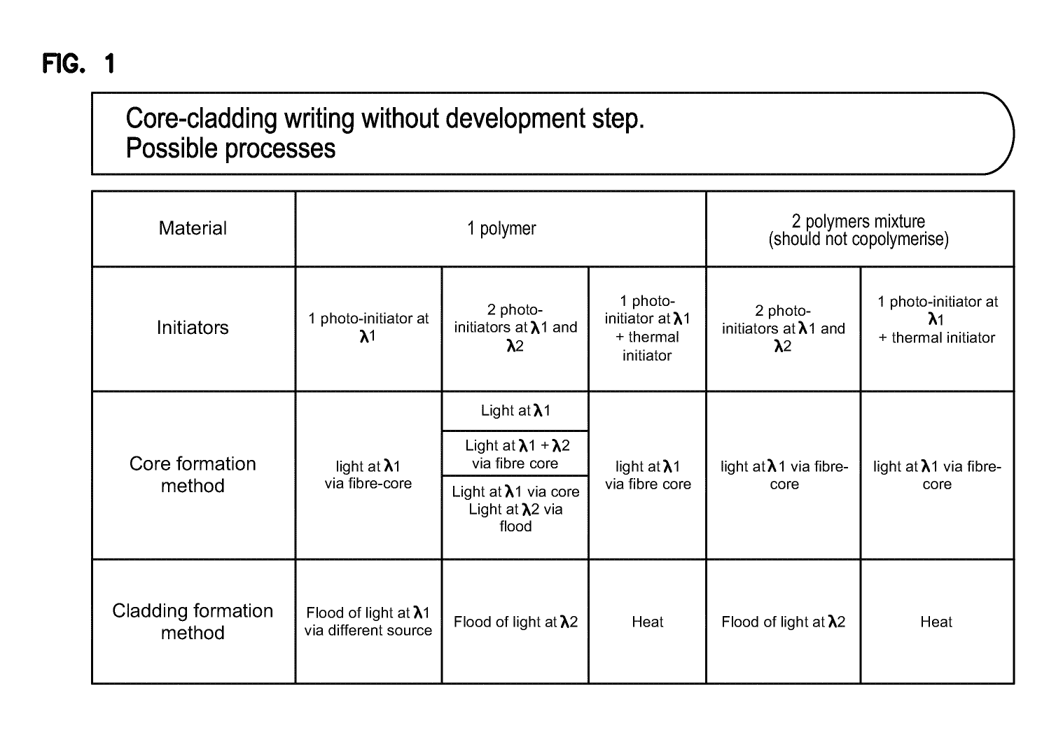

One aspect of the present invention relates to a self-writable waveguide that utilizes a photocurable resin composition, comprising one or more monomers and one or more photoinitiators, which forms a solid polymer bridge between the glass fiber end of one cable, such as a fiber stub and another cable, respectively. The core writing is done with light. The cladding forming is done with light or other methods, such as heat. FIG. 1 shows in matrix form a chart of the various options for the methods of core formation and cladding formation that are part of the present invention. The different wavelengths of light that might be used are indicated as λ1 and λ2. Also indicated in the chart are some noted options for the forming material, and the initiators.

The core writing can be done in the ultraviolet (UV) or visible range of light. Cladding curing from the same polymerizable resin composition is one option through flood UV curing triggered by the same photoinitiator, or another photoinitiator different from the photoinitiator used to form the core. One option for curing the cladding is through flood UV curing triggered by a different photoinitiator that is sensitive at a different wavelength than the one used for the core. Alternatively, a different polymerizable resin composition can be used to form the cladding with flood UV curing. Alternatively, the core can be cured with UV light triggered by a first photoiniator, and visible light used to cure the cladding with a different photoiniator that does not act in the photocuring process of the core. Alternatively, thermal curing of the cladding can be utilized to form the cladding layer. The thermal curing can be done in parallel with a heat shrink sleeve that provides axial pull protection, or with a heat shrinkable boot.

In a polymer without a photoinitiator the light that is launched into the core leaves the fiber and has a finite angle that corresponds to the numerical aperture of the single or multimode fiber. When photoinitiators are formulated into the polymer, the refractive index of the photocured part becomes larger and the outgoing light is immediately narrowed. This focusing effect allows to photocure a core bridge between the two fibers with almost constant diameter over the gap.

The core writing step with the self-writable waveguide can be accomplished by applying light of a first wavelength through a fiber stub mounted in a ferrule of a connector to the polymer area adjacent the fiber stub end wherein the core grows toward the core of the fiber of the cable to be connected. A light of the same wavelength can be applied to the optical fiber to grow the core of the optical fiber towards the core which grows from the stub fiber.

To form the cladding, a different polymerizable resin composition can be applied around the core. If the same polymerizable resin composition is utilized, a different wavelength of light can be applied to initiate curing of the cladding to result in different indexes of refraction between the core and cladding. This can involve different types of photoinitiators and UV photocuring of the core and visible flood light curing of the cladding, such as 532 nanometers. Also, a different spectral distribution may be sufficient. For instance a laser can be used for the core formation and an LED source can be used for the cladding formation. A wavelength overlap may be possible for the formation of the core and the cladding. An alternative to flood curing can be cladding curing by a second wavelength launched via the fiber's cladding. Heat can as well be used as a curing option for the cladding if a thermal initiator is included in the monomer mixture. Use of the same wavelength may be possible in combination with two polymer compounds, one that cures faster for the core, and one that cures slower for the cladding.

The stub fiber and the optical fiber to be joined are held in alignment through an alignment device prior to exposure to the light. The alignment device can include a construction which allows for the passage of the light of the necessary wavelengths needed to cure the core and cladding polymers.

A tool may be provided to assist with proper gap formation between the fiber stub of the connector and the optical fiber of the cable. Core formation is achievable by forming a gap of a desired dimension for each of the different connections made to facilitate repeatable connections for mass production. Some variation in the gap size is anticipated.

An alternative to core-writing, followed by UV flood curing, is to first form the core with the self-writable technology, and then thermal cure the cladding. It is anticipated that known acrylates and polyimide resins work in this method.

A heat-shrink fixation can be added to secure the fiber cable to the connector if desired.

A further alternative is to form the core and the cladding at the same time by flooding and curing via the fiber. The core region will be more exposed to UV yielding a higher index of refraction. This can be a preferable way to form a good core-cladding interface.

For core writing polymerizable resin compositions comprising photoinitiators, the resin compositions need to allow for polymerization of the core. The polymerizable resin compositions can be commercially-available resin compositions, or can be prepared by the combination of one or more monomers with one or more photoinitiators. One example of a polymerizable resin composition is a Norland commercial polymer (acrylate- based) NOA72, with an example UV curing wavelength of 405 nanometers. The same polymer gives a thermal curing with a differential in the indexes of refraction to allow for proper signal propagation. Other examples are Norland commercial polymers NOA61, NOA65, and NOA81. A further example is a polymerizable resin composition with a radical base having a fluorinated-acrylate monomer mixture with Thiol and a photoinitiator (and an example UV curing wavelength of 405 nanometers).

To fabricate the self-writable waveguide technology, different approaches are possible. A cladding substitution method can be utilized where the core is fabricated first by polymerizing a first resin material, removing the uncured material, and replacing it with a second resin material which is then also polymerized to form the cladding. This approach provides flexibility during the various steps by allowing a wider choice of materials for both the core and cladding formation. In order to minimize the losses of the self-writable waveguide technology at the fiber interface, the respective mode profiles should have a maximum overlap in the different optical structures, which requires accurate tuning of the refractive index difference between core and cladding. For example, one way this was achieved was by using a mixture of Ormocore and Ormoclad (Microresist Technology GmbH, Berlin, Germany) as self-writable waveguide core material and Ormoclad for the surrounding cladding. These materials are organically modified ceramics (Ormocers).

Typically, an index of refraction delta between the core and cladding of 0.3% is desired. A core for a single mode fiber is approximately 6-15 microns in diameter and is generally cylindrical in shape. Preferably the properties of the cladding for proper signal transmission need to be present in the area directly contacting the core to a distance of around 10 microns. As the size of the cladding is increased, less attention to the optical properties of the cladding is necessary as the distance from the core increases.

The self-writable waveguides can be a desirable technology for permanently interconnecting two single mode optical fibers, such as in the factory, or in the field. A passive prealignment device is used for relative positioning of the fibers. A gap of the order of 50 to 100 microns separates the end faces and is filled with UV curable polymer or resin. Larger gaps are possible. Optical cores are written by any suitable wavelength that is launched from one or both optical fibers. The claddings are formed by thermal curing or UV flooding. A two mixture approach requires a developing step for removal of the uncured core material. Multimode optical fiber connectivity is also contemplated.

Fiber preparation prior to forming the connection may include: fibers must be cleaved (mechanical or laser cleaves are possible); cleave can be perpendicular or under an angle. Pre-treatment can be applied to the glass surface of the fiber for instance by plasma discharge or a primer can be applied to the glass or other fiber material.

Different classes of UV curable material are considered usable for the present invention. Organically modified ceramics allow for easy development and control of refractive index by mixing. Acrylates and epoxies allow for fast and repeatable core formation with well controlled core size. Primers are used to promote adhesion of the polymer to the glass (for instance by formation of covalent bonds). In commercial formulation such as NOA72 the adhesion promoter is already present in the formulation.

The steps to form a splice with core-writing technology in one example include:
(a) Two fiber ends are aligned and separated by a gap in a mechanical alignment system containing the polymer and the photoinitiators;
(b) The core bridge is written by launching UV or visible light through one or both fibers to be connected;
(c) The cladding is formed by flooding light or by thermal curing of the unpolymerized material to obtain the required refractive index contrast for waveguiding.

The present invention utilizing the self-writable waveguide formation is an alternative to field connectorization that uses index matching gels or oils. Such index matching gels or oils can be less reliable. Self-writable waveguides are solid and do not suffer from slow evaporation like index matching gels and oils. The self-writable technology is also potentially less costly than fusion splicing in the field. Further, the self-writable technology may be used in an environment where fusion splicing would not be permitted due to spacing, a lack of a power source, or a hazard source to the user.

With respect to factory installations, the self-writable technology allows for automation, and parallel application is possible due to low curing power and higher volumes.

In one embodiment of the present invention, the two fibers are prealigned in an in-line or axial arrangement and optically connected using the self-writable waveguide technology. Such a construction could be desirable for terminating fiber stubs with preconnectorized connectors to optical cables in the factory, or in the field.

An alternative embodiment is to position the two fibers parallel to one another and use a deflection device which routes the light path 180 degrees during the core and cladding formation. In one example, each fiber faces a 45 degree reflective surface deflecting the self-writable waveguide during its formation. Other examples include fibers which are not arranged either parallel or axially, but the fibers are arranged to allow for core and cladding formation by a properly angled light deflection device or devices.

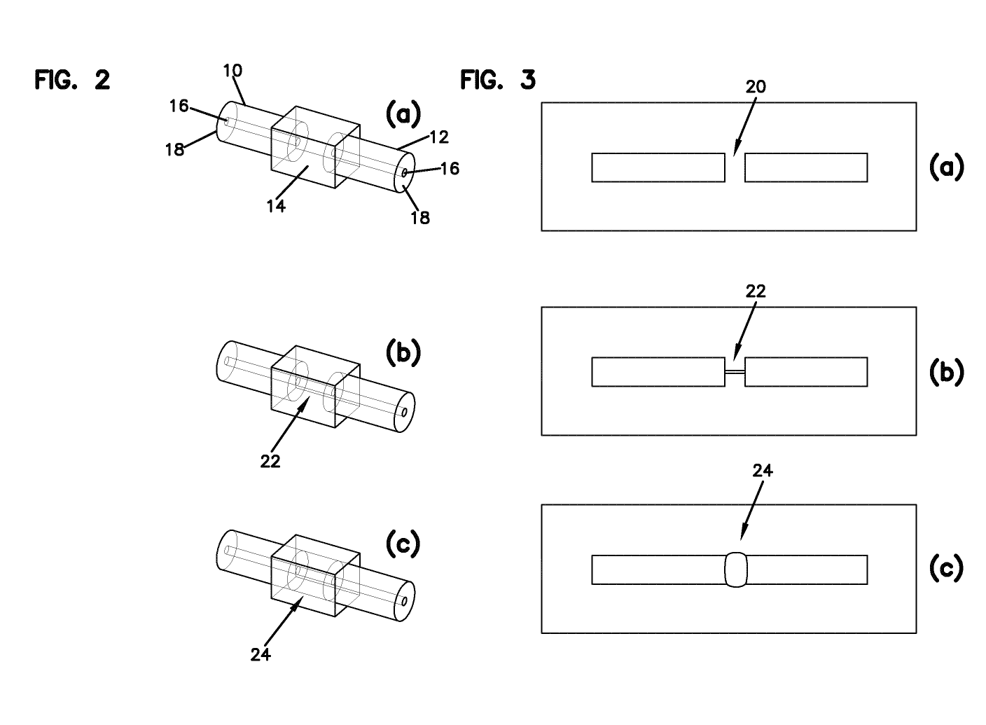

Referring now to FIGS. 2 and 3, a first fiber 10 is shown in position to be joined to a second fiber 12. The fibers 10, 12 are aligned in an alignment device 14. Each fiber 10, 12 includes an inner core 16 and an outer cladding 18. A polymerizable resin material is placed in the gap 20 and exposed to light. One or more photoinitators cause a core bridge 22 to be formed. The cladding bridge 24 is formed by flooding light or by thermal curing of the unpolymerized material to obtain the required refractive index contrast for waveguiding.

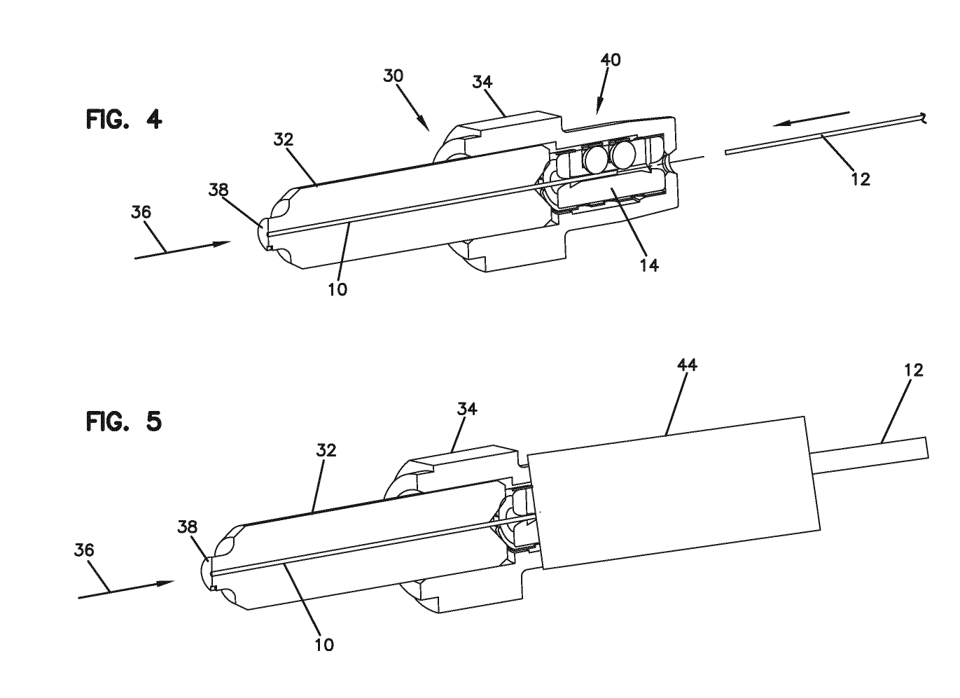

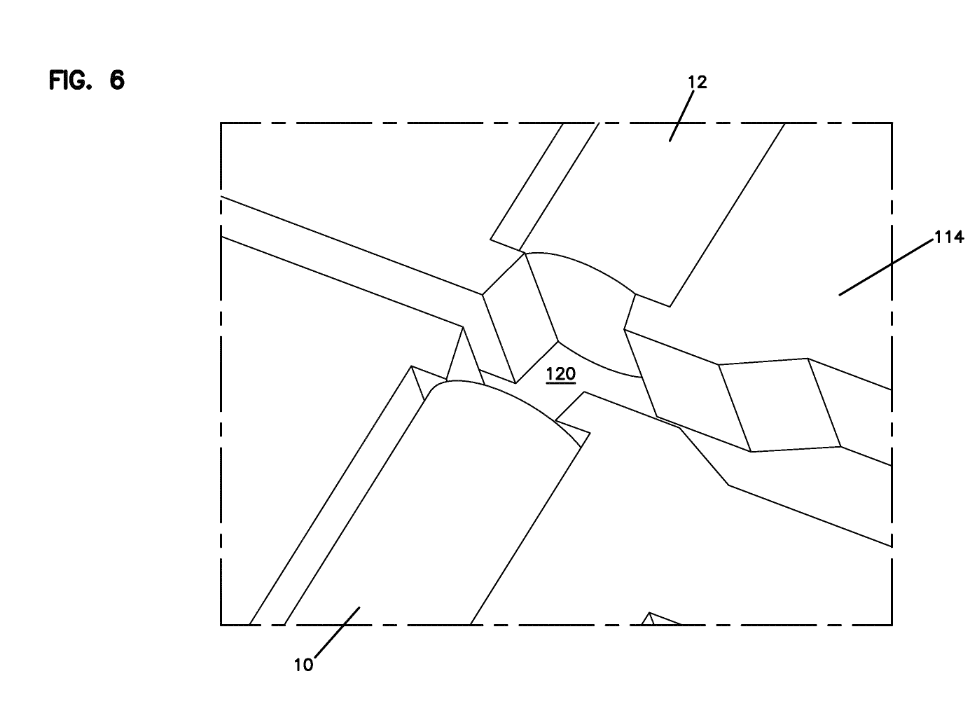

Referring now to FIGS. 4 and 5, a connectorized fiber stub 30 is shown. The first fiber 10 is held by a ferrule 32, such as by glue. Ferrule 32 is held by a hub 34 including a fiber alignment device 14. Fiber alignment device 14 receives second fiber 12 such that a small gap separates the two fiber ends. Light 36 can be transmitted at ferrule end 38 through first fiber 10 to alignment device 14 where the polymerizable resin material is placed in the gap for core formation. Light can also be inserted though fiber 12 to create the core bridge from both fiber ends. The same light 36 can be used for cladding formation, or the cladding can be formed by flooding light 40 or by thermal curing of the unpolymerized material to obtain the required refractive index contrast for waveguiding. If flooding light 40 is used, hub 34 and alignment device 14 have to include light transmissive properties to allow for polymerization of the cladding by the light. A heat-shrink fixation 44 can be added for the thermal cure and/or to secure the fiber cable 12 to the connector if desired. The connectors can be any one of a desired format, such as FC, SC, LC, LX.5, or MPO. FIG. 5 shows fiber 12 with an outer coating or jacket.

The connectorized fiber stub 30 is shown as a ferrulized fiber. The ferrule is attached to the bare glass fiber with glue. Such a construction is a subpart of the full connector. More structure of the connector body can be present during the self-writing process, or it can be added later.

Alignment device 14 in FIGS. 4 and 5 can include any of a variety of structures useful for aligning two fibers, such as V-grooves, balls, rods, or other devices which bring two fibers into axial alignment.

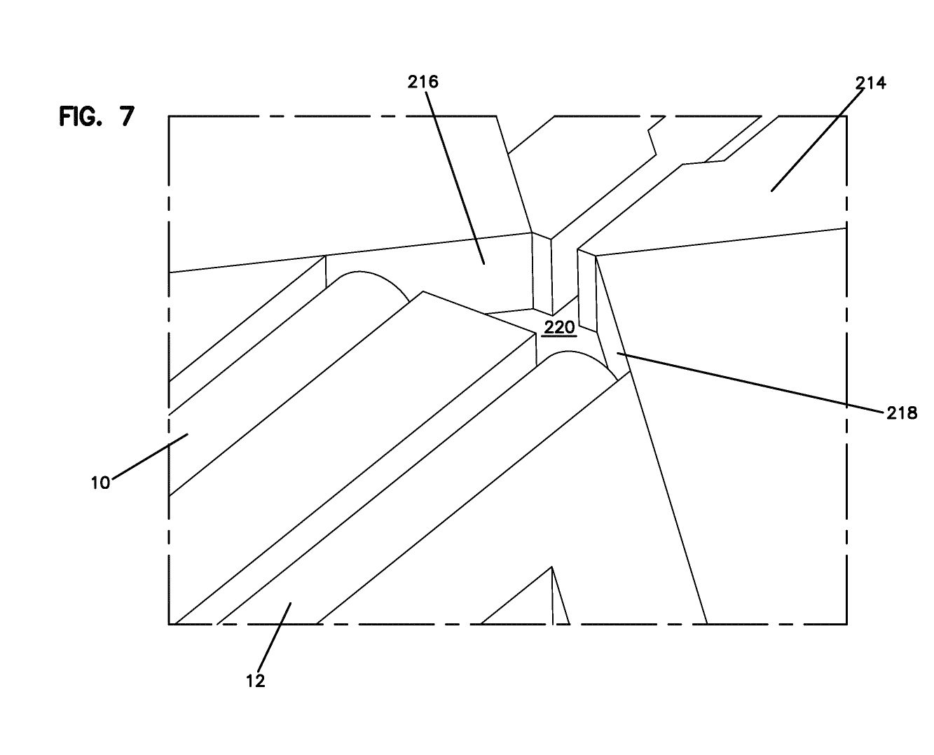

Referring now to FIGS. 6 and 7, two alignment devices 114, 214 are shown. FIG. 6 shows an example axial alignment device 114, where a gap 120 is shown ready for core and cladding formation between fibers 12, 14. FIG. 7 shows an example alignment device 214 that creates a gap 220 for core and cladding formation which uses reflective surfaces 216, 218 to align the fibers 10, 12.

A cold splice of MPO cables and connectors may be possible. The core bridges could be written in parallel.

With the above structures, formulations and methods, two optical fibers can be connected using self-writable waveguides. The result is a cold splice having light guiding capability. As noted, some of the disclosed structures, formulations and methods have advantages for field splicing and field termination. Although, the various disclosed structures, formulations, and methods may have advantages for factory splicing and factory termination. The various structures, formulations and methods can be used to connectorize a cable using stubbed connectors.

In a further example of a method of forming a self-writable waveguide, two fibers are cleaved and their end faces are separated by a distance, such as 50 micrometers, and the unpolymerized material applied in between and around the fiber tips. One example of a useful material is NOA68. Both the core and the cladding can be formed simultaneously. In one example, laser light is launched through both fibers at 10 microwatts, at 405 nanometer wavelengths for thirty seconds, and the cladding is formed at the same time by polymerization using a uniform UV flood exposure, such as Hamanatsu LC 8 with a 365 nanometer filter, for 30 seconds at 2 mWcm².

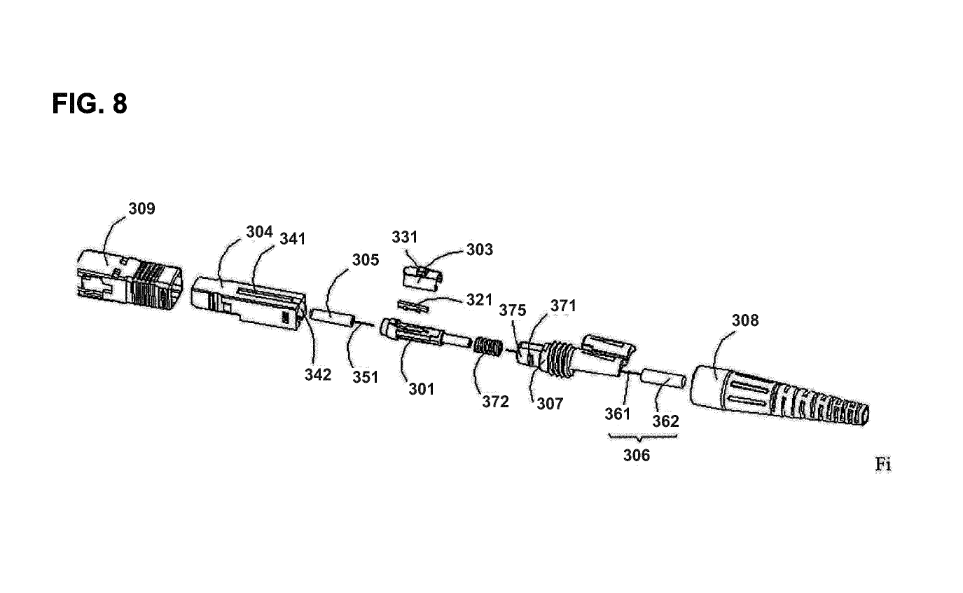

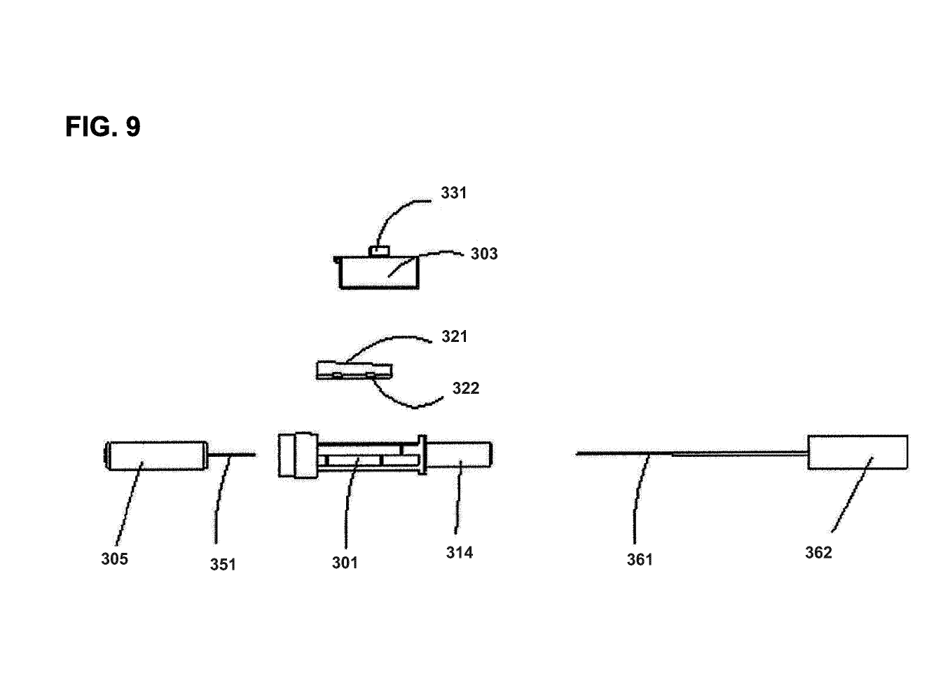

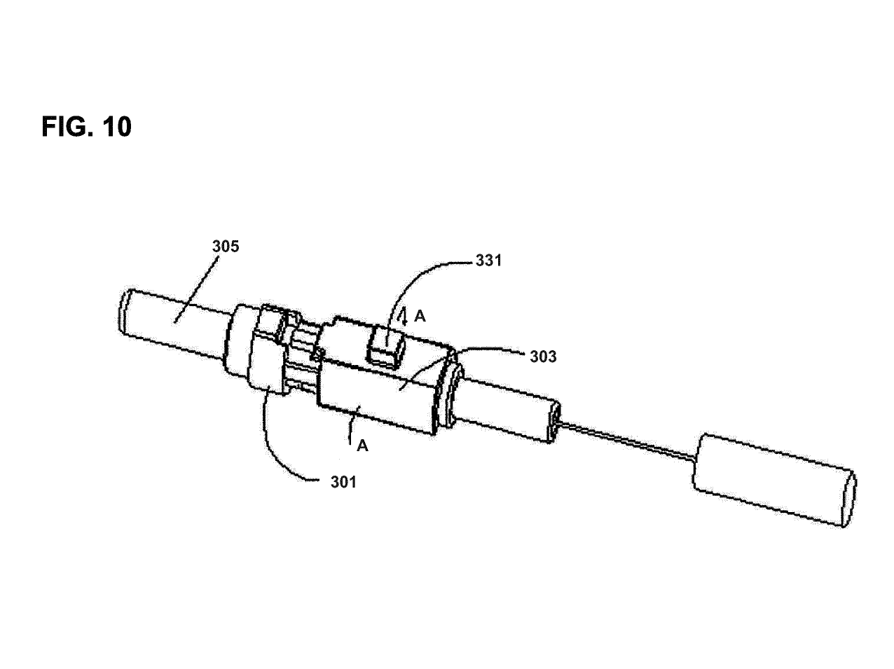

Referring now to FIGS. 8-10, an apparatus is shown which is useful for connectorizing a cable to a fiber stub held by a ferrule. FIGS. 8-10 show a device useful to connectorize a cable using a fiber pre-stubbed connector. Base 301 receives a first fiber 351 and a second fiber 361 which are to be joined using one or more of the above-noted methods. First fiber 351 is affixed to a ferrule 305, such as with an epoxy. Second fiber 361 extends from cable 362. A first cover element 321 and a second cover element 303 are mounted to base 301 to position the fibers in alignment for processing. Second fiber 361 is received in passage 314 of base 301. As shown in FIG. 10, the two fibers are ready for exposure to the polymerizable material and the polymerizing light. Base 301 and cover elements 303, 321 allow for the passage of the light waves necessary to polymerize the polymerizable material to form the self-written waveguide. Once the waveguide is formed, a remainder of the connector device can be assembled around the device of FIG. 10. In particular, FIG. 8 shows the elements useful for completing the connector body of an SC connector. A first element 304 fits over ferrule end at ferrule 305. A spring 372 and a rear element 307 mate to front element 304. Bump 331 is positioned in slot 341. A boot 308 is positioned around cable 362. An outer housing 309 completes the structure of the SC connector which is matable in an SC adapter to another SC connector. The apparatus of FIGS. 8-10 includes structures of a commercially available connecter called “F-Light” by TE Connectivity. Further details of the connector structure of FIGS. 8-10 are shown in WO 2013/021294, the disclosure of which is incorporated by reference. Another connector structure that may be used is shown in WO 2013/005137, the disclosure of which is incorporated by reference.

During the self-writing process using the apparatus of FIGS. 8-10, the device of FIG. 10 is connectable to another connector through an adapter, such as an SC connector and an SC type adapter. The adapter is modified in order to position the two ferrules in alignment to allow insertion of the core writing light from the manufacturing connector to the connector to be formed. The adapter receives a conventional SC connector on one side and the device of FIG. 10 on the other side for delivery of the core-forming light. As noted, the elements of the connector device of FIG. 10 also allow for the transmission of the flooding light source to form the cladding.

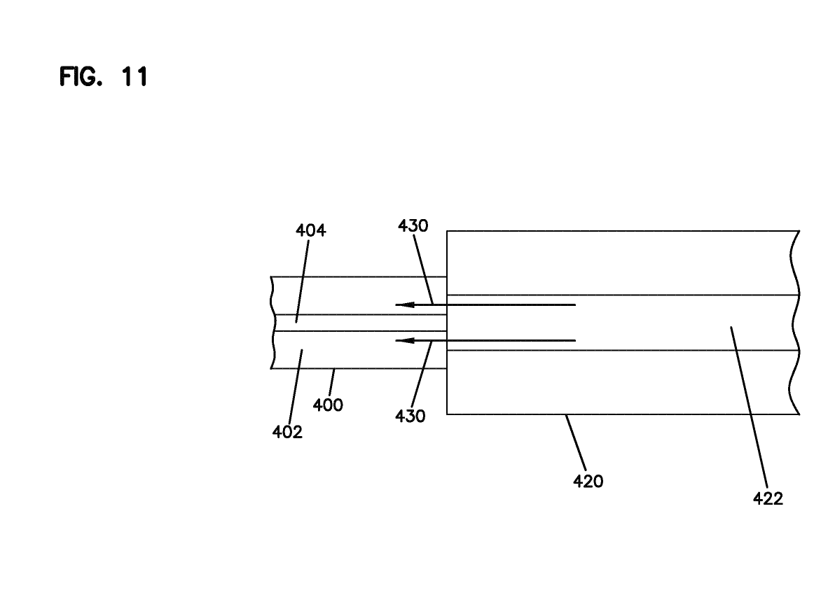

Referring now to FIG. 11, an alternative device and method is shown for curing the cladding material. A first fiber 400 includes a cladding 402 and a core 404 which is used to form the bridging core and cladding to the second fiber. As above, light can be inserted into core 404 for forming a core portion of the self-written waveguide. Instead of using flooding light from the side for the cladding formation, light can also be inserted into the cladding portion of the self-written waveguide. To form the cladding, a different light source at a different wavelength can be inserted from the core 422 of cable 420, wherein the light leaves core 422 and enters the cladding 402 for transmission to the area of the waveguide where cladding formation occurs. Core 422 of cable 420 is larger than core 404, so that some of the light 430 from core 422 enters the cladding 402 and travels to the end where the core and cladding are being written.

1. A method for forming a splice between a connectorized fiber stub and a cable with core-writing technology, comprising:
(a) aligning two fiber ends separated by a gap in a mechanical alignment system containing polymerizable material and a photoinitiator;
(b) forming a core bridge by launching UV or visible light through one or both fibers to be connected; and
(c) forming the cladding by flooding light or by thermal curing of polymerizable material to obtain the required refractive index contrast for waveguiding.

2. A method for forming a splice between two fibers with core-writing technology, comprising:
(a) aligning two fiber ends separated by a gap in a mechanical alignment system containing polymerizable material and a photoinitiator;
(b) forming a core bridge by launching UV or visible light through one or both fibers to be connected; and
(c) forming the cladding by flooding light or by thermal curing of polymerizable material to obtain the required refractive index contrast for waveguiding.

3. A method for forming a splice between two fibers with core-writing technology, comprising:
(a) positioning two fiber ends separated by a gap in a mechanical alignment system with a reflective device and containing polymerizable material and a photoinitiator;
(b) forming a core bridge by launching UV or visible light through one or both fibers to be connected; and
(c) forming the cladding by flooding light or by thermal curing of polymerizable material to obtain the required refractive index contrast for waveguiding.

4. A fiber optic connector including a connectorized fiber stub connected to a fiber optic cable using one of the methods of claim 1.

5. The fiber optic connector of claim 4, wherein the connectorized fiber stub includes a ferrule.

6. The fiber optic connector of claim 5, wherein the connectorized fiber stub includes a hub which holds the ferrule.

7. The fiber optic connector of claim 5, wherein the connectorized fiber stub includes a connector body for connecting to a fiber optic adapter.
